(19) United States
(12) Patent Application Publication
(10) Pub. No.: US 2022/0136139 A1
(43) Pub. Date: May 5, 2022

(54) PROCESS AND DEVICE FOR SPLITTING A TAPE

(71) Applicant: TEIJIN ARAMID B.V., Arnhem (NL)

(72) Inventors: Edo MUGGE, Wijchen (NL); René JOURNÉE, Loo (gld) (NL)

(73) Assignee: TEIJIN ARAMID B.V., Arnhem (NL)

(21) Appl. No.: 17/528,570

(22) Filed: Nov. 17, 2021

Related U.S. Application Data
(63) Continuation-in-part of application No. 16/080,109, filed on Aug. 27, 2018, now Pat. No. 11,208,737.

(30) Foreign Application Priority Data
Mar. 3, 2016 (EP) 16158464.4

(51) Int. Cl. D01D 5/42; D07B 1/02; D07B 5/10; D07B 7/02

(52) U.S. Cl. CPC D01D 5/423; D07B 1/02; D07B 5/10; D07B 2205/201; D07B 2201/104; D07B 2201/2003; D07B 7/025

(57) ABSTRACT

A process and a splitter for splitting a tape of a uniaxially oriented material. The tape is passed in a process direction over a static splitting profile having a row of teeth, e.g., with a cutting edge extending in the process direction. The tape is split to form a material comprising a plurality of parallel strips interconnected by fibrils. The split material can for example be used for the production of high tensile ropes or laminates.

This application is a Continuation-in-Part of application Ser. No. 16/080,109, filed Aug. 27, 2018, which is a national stage of PCT/EP2017/051653, filed Jan. 26, 2017, which claims priority to EP 16158464.4, filed Mar. 3, 2016. The entire contents of the prior applications are hereby incorporated by reference herein in their entirety.

The invention pertains to a process and a device for splitting a tape, in particular of a uniaxially oriented thermoplastic material, e.g., for producing a rope, in particular high-tensile ropes comprising one or more strands made of uniaxially oriented tape material. Such ropes are used for high tensile loads, such as with mooring, towing, lifting, offshore installation, fishing lines or nets, or cargo nets. Such tapes can also be used to form one or more layers in a laminate.

WO 2013/092622 discloses a rope made of by simultaneously twisting and fibrillating strands of uniaxially oriented tapes of ultra-high molecular weight polyethylene (UHMWPE). The drawback of such a rope making process is that the resulting rope is not uniform over its length. Other ropes are produced using tapes with a small width, e.g., of 2 mm or less, such as the Endumax® 2 mm tapes of Teijin. Such tapes may for example be made by cutting a tape of a larger width to a number of tapes having the desired smaller width. Cutting narrow tapes from a wider one has the drawback that fibrils are cut so the overall joint tensile strength of the narrower tapes would be less than the tensile strength of the original wider tape. The wide tapes are supplied as a roll and cut into strips, which are subsequently wound separately. In a next step, the wound strips are unwound and twisted to form a cord or rope.

It has also been proposed to fibrillate oriented sheets of thermoplastic material, for instance in GB 1 269 823. This publication teaches to pass an extruded foamed thermoplastic sheet between the nip of two intermeshing rollers.

It is an object of the invention to provide a tape material overcoming the above mentioned problems.

The object of the invention is achieved with a process wherein a tape of a uniaxially oriented material is passed in a process direction over a splitting profile having a row of teeth splitting the passing tape into a material comprising a plurality of parallel strips interconnected by fibrils, the fibrils having a width which is smaller than a width of the strips. This way, the tape is split into a desired number of strips which are still interconnected by fibrils. These fibrils are not cut or damaged. Due to the fibrils, the individual strips do not have to be rewound before they can be used to twist a rope. The rope can directly be made from the split tape. This simplifies the overall process. It has also been found that this substantially increases the tensile strength of the final product.

The teeth may for example be triangular when viewed in process direction.

Particularly good results are achieved if the splitting profile is static, i.e., motionless during the process, so the splitting profile as a whole does not rotate relative to the passing tape and has a fixed position. The static splitting profile can for example be an axis or shaft with triangular teeth, e.g., showing a zigzag pattern when viewed in process direction. The static axis or shaft can be cylindrical or non-cylindrical. The teeth do not need to extend along the entire circumference of the axis or shaft.

In a specific embodiment, each of the teeth may comprise a cutting edge extending in process direction, at least at the position where the teeth engage a passing tape during the process. The cutting edges may for example define a circle or circular segment in side view, the teeth being coaxially arranged. In side view (i.e., in a horizontal direction perpendicular to the process direction), the radius of the cutting edges may for example be at most 25 mm, e.g., at most 20 mm. Larger radii can also be used. The distance between the cutting teeth may for example be about 0.25-5 mm, e.g., about 1.5-2.5 mm, e.g., about 1.8-2.2 mm. The height of the cutting edges may for example be in the range of 0.5-12 mm, e.g. about 1-5 mm, e.g., about 2-3 mm.

The tape to be split may for example pass the splitting profile with a processing speed of at least about 1 m/min or less, e.g., at least about 2 m/min, e.g., to a maximum of about 100 m/min, or even higher.

Good results are obtained if the tape is fed to the splitting profile with an entrance angle of 0-90 degrees to the horizontal.

The tape may for example exit the splitting profile with an exit angle of 0-90 degrees to the horizontal.

During the splitting process the web tension may for example be about 0-3 N/mm.

The invention also relates to a tape of a uniaxially oriented material comprising as plurality of parallel strips interconnected by fibrils. Each of the strips is connected at one or at both of its longitudinal sides to an adjacent parallel strip. With uniaxially oriented material is meant that the tapes exhibit an orientation of the polymer chains in one direction. Such material shows anisotropic mechanical properties.

The uniaxially oriented material may for example be or comprise polyethylene, e.g., UHMWPE. The UHMWPE may be linear or branched. Linear polyethylene has less than 1 side chain per 100 carbon atoms, e.g., less than 1 side chain per 300 carbon atoms, a side chain or branch generally containing at least 10 carbon atoms. Side chains can be measured by FTIR on a 2 mm thick compression moulded film. Linear polyethylene may further contain up to 5 mol % of one or more other copolymerisable alkenes, such as propene, butene, pentene, 4-methylpentene, and/or octene. The linear polyethylene can be of high molar mass with an intrinsic viscosity (IV, as determined on solutions in decalin at 135° C.) of at least 4 dl/g; e.g., of at least 8 dl/g, e.g., of at least 10 dl/g.

The ultra-high molecular weight polyethylene may for example have a weight average molecular weight (Mw) of at least 500 000 gram/mol in particular between 1*10⁶ gram/mole and 1*10⁸ gram/mol. In one embodiment, the polyethylene has a number average molecular weight (Mn) of at least 2.0*10⁵ g/mol. The Mn may be at least 5.0*10⁵ g/mol, more in particular at least 8.0*10⁵ g/mol, or even at least 1.0 million g/mol, or even at least 1.2 million gram/mol. The use of a polymer with a relatively high Mw has the advantage of a relatively high strength; the use of the polymer with a relatively high Mn has the advantage that it contains a relatively low amount of low-molecular weight polyethylene, and as it is believed that the properties of the tape derived from the high molecular weight molecules the presence of fewer low-molecular weight molecules will lead to a tape with better properties. The use of a polymer with a relatively high Mw in combination with a relatively high Mn may be particularly preferred. The Mn and Mw may be determined as is described in WO2010/079172. Reference may also be made to S. Talebi et al. in Macromolecules 2010, Vol. 43, pages 2780-2788. In one embodiment, the tapes are based on disentangled PE, e.g., as described in WO 2009/007045, and WO2010/079172.

To form a rope the tapes can be combined with further tapes, strips, yarns and/or filaments, which may for instance comprise polyolefins, polyesters, polyvinyl alcohols, polyacrylonitriles, polyamides, liquid crystalline polymers and ladder-like polymers, such as polybenzimidazole or polybenzoxazole.

Tapes of uniaxially oriented UHMWPE may be prepared by drawing films. Films may be prepared by compacting a UHMWPE powder at a temperature below its melting point and by rolling and stretching the resulting polymer. An example of such a process is disclosed in U.S. Pat. No. 5,578,373.

Alternatively, UHMWPE powder can be fed to an extruder, extruding a film at a temperature above the melting point. Before feeding the polymer to the extruder, the polymer may be mixed with a suitable liquid organic compound, for instance to form a gel.

The UHMWPE films can then be drawn or stretched in one or more consecutive steps to obtain the desired uniaxially oriented tapes.

Before splitting, the width of the tapes can for example be more than 5 mm, e.g., more than 8 mm, e.g., more than 15 mm, e.g., more than 100 mm, e.g., up to about 500 mm. The thickness of the tapes may for example be at least about 30 μm, e.g., up to about 200 μm

The areal density of the tapes can for example be between 2 and 200 g/m², e.g., between 10 and 170 g/m², e.g., between 10 and 100 g/m², e.g., between 20 and 60 g/m².

Linear density is measured by determining the weight in mg of 10 meters of material and is conveniently expressed in dtex (g/10 km) or denier (den, g/9 km). The linear density of the tape may depend upon the areal density of the tape, the width of the tape and the twist level of the tape. The linear density of the tape may for example be in the range from 400 dtex (360 den) to 200.000 dtex (180000 den), e.g., in the range from 1000 dtex (900 den) to 100000 dtex (90000 den), e.g., in the range from 2000 dtex (1800 den) to 50000 dtex (45000 den).

The tensile strength of the tapes prior to splitting depends on the used type of UHMWPE and on their stretch ratio. The tensile strength of the tapes may for example be at least 0.9 GPa, e.g., at least 1.5 GPa, e.g., at least 2.1 GPa, e.g., at least 3 GPa.

In one embodiment, the tapes may have a 200/110 uniplanar orientation parameter Φ of at least 3. The 200/110 uniplanar orientation parameter Φ is defined as the ratio between the 200 and the 110 peak areas in the X-ray diffraction (XRD) pattern of the tape sample as determined in reflection geometry. The 200/110 uniplanar orientation parameter gives information about the extent of orientation of the 200 and 110 crystal planes with respect to the tape surface. For a tape sample with a high 200/110 uniplanar orientation the 200 crystal planes are highly oriented parallel to the tape surface. It has been found that a high uniplanar orientation is generally accompanied by a high tensile strength and high tensile energy to break. It may be preferred for the 200/110 uniplanar orientation parameter Φ to be at least 4, more in particular at least 5, or at least 7. Higher values, such as values of at least 10 or even at least 15 may be particularly preferred. The theoretical maximum value for this parameter is infinite if the peak area 110 equals zero. High values for the 200/110 uniplanar orientation parameter are often accompanied by high values for the strength and the energy to break. The 200/110 uniplanar orientation parameter Φ may be determined as is described in WO2010/007062, page 9, line 19, through page 11, line 17.

The tape is split to form a material comprising a plurality of parallel strips interconnected by fibrils. More particularly, the processed tape forms a uniaxially oriented material having a direction of uniaxial orientation and comprising a plurality of parallel strips with side edges extending parallel to said direction of uniaxial orientation, the strips being interconnected by fibrils, the fibrils having a width which is smaller than a width of the strips, with one of said strips bordering one longitudinal side edge of the material and another one of said strips bordering an opposite longitudinal side edge of the material, e.g., at least when the material is in a flattened and unfolded condition.

The number of fibrils per cm strips may for example be up to about 100, e.g., up to about 60, e.g., up to about 40. The fibrils can have an average diameter of up to about 250 micrometer, e.g., between 10-250 micrometer. The diameter of the fibril may vary slightly over the full length and over a cross section of the respective fibril, so in this respect average diameter refers to a diameter averaged over the full length and over any cross section of the respective fibril.

The strips typically have a flat cross section, i.e. having a strip width which is larger than the strip thickness over the full length of the strip, e.g., having a rectangular or oval cross section. The width of the strips can for example be at least 0.25 mm, e.g., up to about 5 mm.

In a particular embodiment, the process of splitting the tape results in a uniaxially oriented material having a direction of uniaxial orientation and comprising a plurality of parallel strips having a flat cross section and a width of 0.25-5 mm and side edges extending parallel to said direction of uniaxial orientation, the strips being interconnected by fibrils having a width below 0.25 mm, with one of said strips bordering one longitudinal side edge of the material and another one of said strips bordering an opposite longitudinal side edge of the material, e.g., at least when the material is in a flattened and unfolded condition.

After the tape is split into the plurality of strips interconnected by fibrils, a rope may be assembled by twisting one or more strands comprising the interconnected strips. Such strands may also comprise more than one sub-strands or secondary strands. Each strand or secondary strand may comprise at least one split tape.

The twisted strand and/or the rope comprising the twisted strand may subsequently be stretched. Such a post-stretching step may for example be performed at elevated temperature but below the melting point of the lowest melting tape in the strands (heat-stretching). For a rope containing tape comprising UHMWPE, the temperature may for example be in the range 100-150° C.

The rope may for instance have a substantially circular cross section or an oblong cross-section, such as a flattened, oval, or rectangular cross section. Such oblong cross-sections may for example have width to height ratio in the range from 1:1.2 to 1:4.

The rope may be for example be laid, braided, plaited, parallel, with or without a core, having any suitable number of strands. A parallel rope may be constructed with at least a single strand. The number of strands in more complex ropes may e.g., be at least 3, e.g., at most 50, e.g., at most 25, to arrive at a combination of good performance and ease of manufacture.

Braiding provides a robust and torque-balanced rope that retains its coherency during use. Suitable braiding constructions include soutache braids, tubular or circular braids, and flat braids. Tubular or circular braids generally comprise two sets of strands that are intertwined, with different patterns possible. The number of strands in a tubular braid may vary widely. Especially if the number of strands is high, and/or if the strands are relatively thin, the tubular braid may have a hollow core; and the braid may collapse into an oblong shape. The number of strands in a braided rope may for example be in the range of 4-48.

Alternatively, the rope can be of a laid construction having a lay length, wherein the lay length, i.e. the length of one turn of a strand in a laid construction, or of a braided construction having a braiding period, i.e. the pitch length of the braided rope, which is in the range of from 4 to 20 times the diameter of the rope. A higher lay length or braiding period may result in a rope having higher strength efficiency. The lay length or braiding period may for instance be about 5-15 times the diameter of the rope, e.g., about 6-10 times the diameter of the rope.

Optionally, the rope and/or the tapes in the rope may be coated with a coating, e.g., for improving abrasion resistance or bending fatigue or other mechanical or physical properties. Such coatings can be applied to the tape before construction of the rope, or onto the rope after it is constructed. Examples include coatings comprising silicone oil, bitumen, polyurethane or mixtures thereof. The coating of the rope may for example be about 2.5-35 wt % by total weight of the rope.

The tapes can also be used to form a layer in a laminate, e.g. a cross-ply laminate. The laminate may for example comprise a foil layer and layer formed by at least one tape of the present disclosure. The tape can be spread before lamination.

The invention also relates to a splitter for splitting a tape of uniaxially oriented material comprising a splitter profile, a tape feeder for feeding tape to the splitter profile in a process direction, the splitter profile having a row of parallel teeth which are triangular when viewed in the process direction, the teeth having cutting edges for engaging and splitting the tape, said cutting edges extending in the process direction, at least at a position where the cutting edge engages a passing tape during the splitting process, and having a fixed position and orientation relative to the tape feeder.

Particularly good results are obtained if the splitter further comprises a counter profile, the splitter profile and the counter profile forming a nip for passage of the tapes, the counter profile having teeth intermeshing with those of the splitter profile. Preferably, the counter profile is also static, i.e., the teeth of the counter profile having a fixed position and orientation relative to the splitter profile. During the splitting process, the tape engages the cutting edges at the position of the nip.

The invention is further explained with reference to the accompanying drawings.

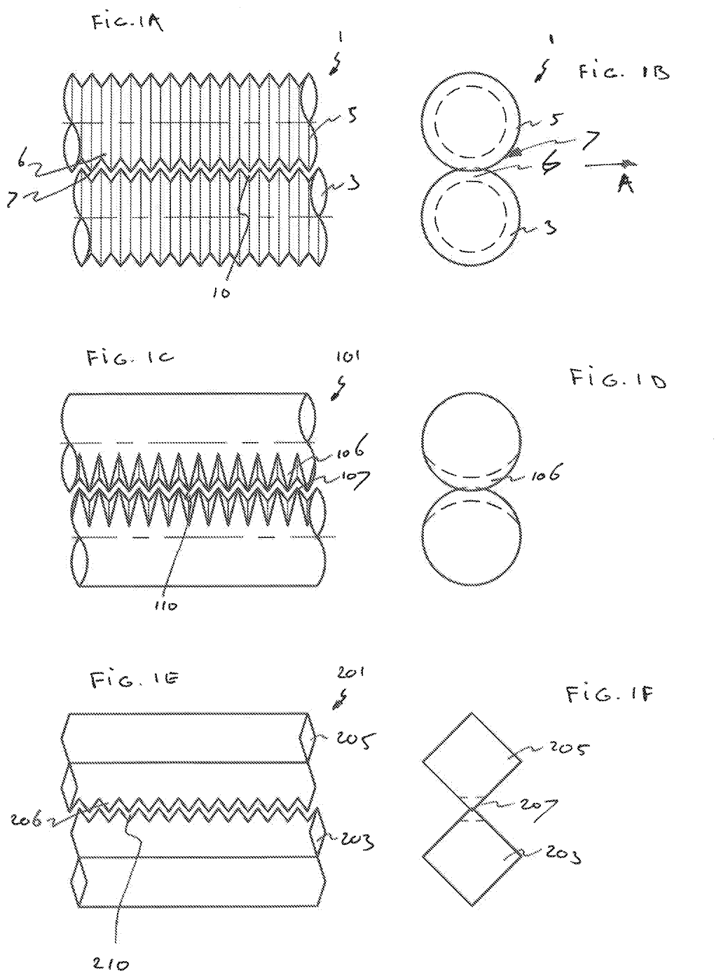

FIG. 1A: shows in front view an exemplary embodiment of a splitter;

FIG. 1B: shows the splitter of FIG. 1A in side view;

FIG. 1C: shows in front view a second exemplary embodiment of a splitter;

FIG. 1D: shows the splitter of FIG. 1C in side view;

FIG. 1E: shows in front view a third exemplary embodiment of a splitter;

FIG. 1F: shows the splitter of FIG. 1E in side view;

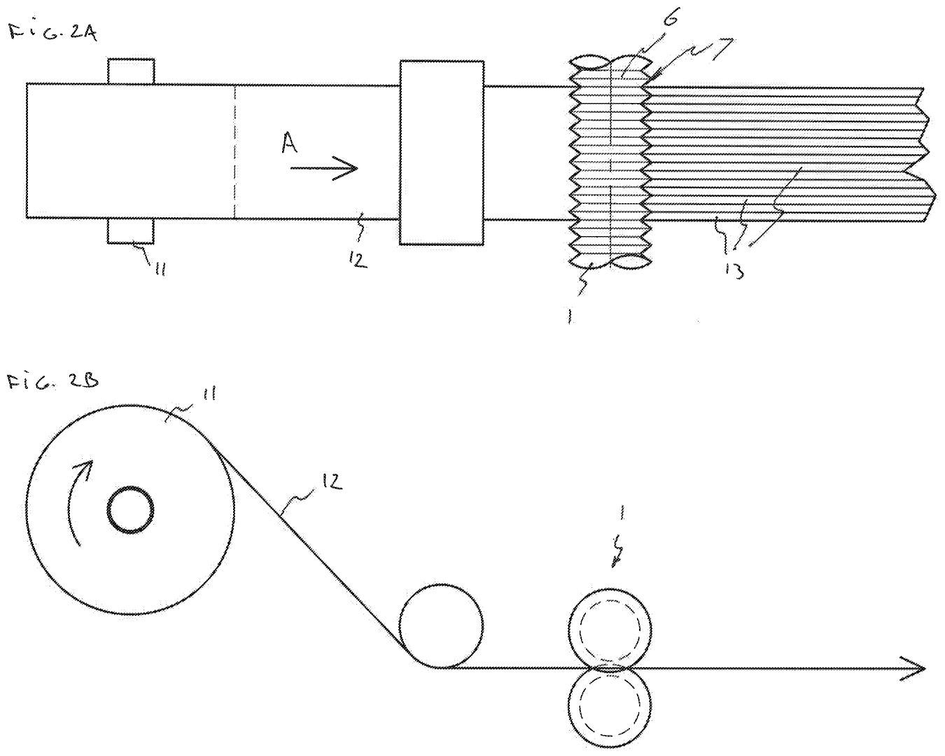

FIG. 2A: shows an arrangement with the splitter of FIG. 1A in top view during a splitting process;

FIG. 2B: shows the arrangement of FIG. 2A in side view;

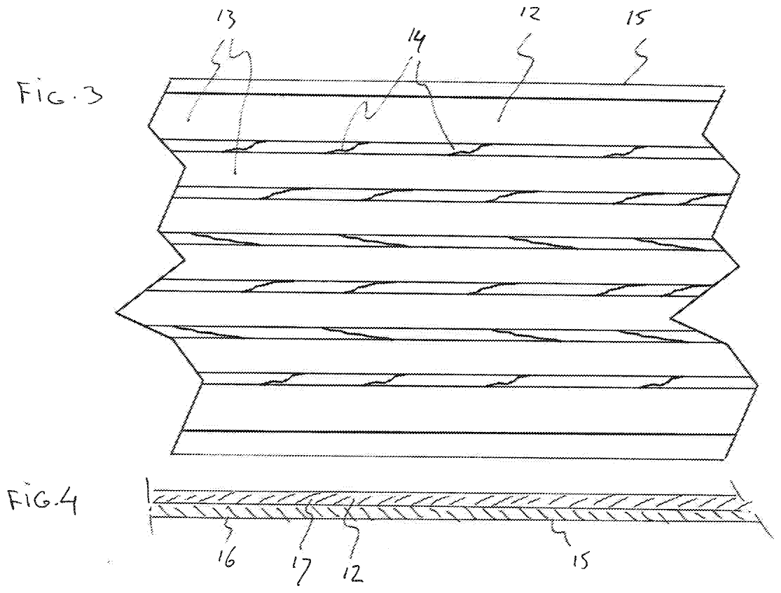

FIG. 3: shows in top view a laminate comprising processed tape material;

FIG. 4: shows the laminate in side view.

FIGS. 1A and 1B show a splitter 1 for splitting UHMWPE tapes, or tapes of a similar high tensile strength material, to form strips interconnected by fibrils, e.g., for twisting a high tensile rope. The splitter 1 comprises a profile 3 and a counter profile 5. The profile 3 and the counter profile 5 are parallel and have teeth 6 with cutting edges 7. The teeth 6 are triangular when viewed in a direction perpendicular to a longitudinal axis X of the profile 3. The teeth 6 of the counter profile 5 intermesh with those of the profile 3 to form a zig-zag nip 10 for passage of the tapes. The tapes pass the nip 10 in a process direction A perpendicular to the plane of the drawing in FIG. 1 (see FIG. 2). The cutting edges 7 extend in the process direction A, at least at the position of the nip 10.

In the shown embodiment the profile 3 and the counter profile 5 are two parallel mainly cylindrical bodies. However, the profile 3 and counter profile 5 may have any other suitable shapes, provided that they define a zig-zag nip between intermeshing triangular cutting edges. The profile 3 and the counter profile 5 are static, so they have a fixed position and orientation and do not rotate during the process.

FIGS. 1C and 1D show an alternative splitter 101 with teeth 106 only at and near the position of the zigzag nip 110. A similar embodiment 201 is shown in FIGS. 1E and 1F, having intermeshing teeth 206 only at the position of the nip 210. The profile 203 and the counter profile 205 have rectangular cross sections. Since the profile and the counter profile are static and do not rotate, they can have any cross section.

FIG. 2A shows in top view how a tape 12 of a uniaxially oriented material is fed from a tape feeder 11 is guided via the splitter 1 of FIGS. 1A and 1B. The cutting edges 7 of the teeth 6 of the profile 3 and the counter profile 5 split the tape 12 into a plurality of parallel strips 13. These strips 13 are not completely separated but are still interconnected by individual fibrils 14, as is shown in FIG. 3, showing the split material in a flat and unfolded condition, embedded in a matrix to form a laminate 15.

As is shown in FIG. 3, the fibrils 14 have a width which is smaller than a width of the strips 13. One of the strips 13A borders a longitudinal side edge of the material and another strip 13B borders an opposite longitudinal side edge of the material. The strips 13A, 13B bordering the two longitudinal side edges of the material are connected to an adjacent strip 13 by fibrils 14 at only one of their respective sides, while all other strips 13 connect to interconnecting fibrils 14 at both sides.

The strips 13 have a flat cross section with a width of 0.25-5 mm, whereas the fibrils 14 have a thread-like cross section and an average diameter below 0.25 mm.

The split tape material 12 can for example be used in a laminate 15, as is shown in FIGS. 3 and 4. The laminate 15 comprises a foil layer 16 and layer 17 formed by the split tape material 12. The split tape material 12 is spread to increase the distance between the individual strips 13 of the split tape material 12. The foil carrier may for instance be an LDPE or HDPE layer. The split tape material 12 can be laminated at a temperature just above the melting temperature of the foil carrier but below the melting temperature of the tape material. The laminate can have more layers formed by one or more split tape materials, e.g. between the enforced layer and the foil and/or on top of the foil and/or on top of the tape-reinforced layer. Such laminates have a high impact resistance.

1. A process of splitting a tape of a uniaxially oriented material, wherein the tape is passed in a process direction over a static splitting profile having a row of teeth splitting the passing tape into a material comprising a plurality of parallel strips interconnected by fibrils, the fibrils having a width which is smaller than a width of the strips.

2. The process of claim 1, wherein the teeth are parallel, each one of the teeth having a cutting edge extending in the process direction.

3. The process of claim 1, wherein the teeth are triangular in cross section perpendicular to the process direction.

4. The process of claim 2, wherein the cutting edges of each of the teeth define a circle or circular segment, the teeth being coaxially arranged.

5. The process of claim 1, wherein the tape passes the splitting profile with a processing speed of at least 1 m/min, e.g., up to about 100 m/min.

6. The process of claim 1, wherein the tape is fed to the splitting profile with an entrance angle of 0-90 degrees to the horizontal.

7. The process of claim 1, wherein the tape is fed to the splitting profile with an exit angle of 0-90 degrees to the horizontal

8. The process of claim 1, wherein the uniaxially oriented material is polyethylene.

9. The process of claim 1, wherein the uniaxially oriented material is UHMWPE.

10. A process for the production of a rope, wherein a tape of a uniaxially oriented material is split into a plurality of strips interconnected by fibrils, and wherein the strips are subsequently twisted to form the rope.

11. A uniaxially oriented material having a direction of uniaxial orientation and comprising a plurality of parallel strips with sides extending parallel to said direction of uniaxial orientation, the strips being interconnected by fibrils, the fibrils having a width which is smaller than a width of the strips, with one of said strips bordering one longitudinal side edge of the material and another one of said strips bordering an opposite longitudinal side edge of the material.

12. The material of claim 11, the plurality of parallel strips having a width of 0.25-5 mm and the fibrils having a width below 0.25 mm.

13. A laminate comprising a foil layer and a layer at at least one side of the foil layer, wherein the layer is formed by laminating at least one layer of a material according to claim 11.

14. A rope comprising one or more twisted materials according to claim 11.

15. A splitter for splitting tapes of a uniaxially oriented material, the splitter comprising a splitter profile, a tape feeder for feeding tape to the splitter profile in a process direction, the splitter profile having a row of teeth which are triangular when viewed in the process direction, having a fixed position and orientation relative to the tape feeder.

16. The splitter of claim 15, each one of the teeth having parallel cutting edges for engaging and splitting the tape, said cutting edges extending in the process direction.

17. The splitter of claim 15, further comprising a counter profile, wherein the splitter profile and the counter profile form a nip for passage of the tapes, the counter profile having teeth intermeshing with the teeth of the splitter profile.
